(19) United States
(12) Patent Application Publication
(10) Pub. No.: US 2003/0038397 A1
(43) Pub. Date: Feb. 27, 2003

(54) Apparatus and method for molding an animal body part

(76) Inventors: Mel MacAllister, Weare, NH (US); Sonia L. Fogg, Bedford, NH (US)

Correspondence Address: MESMER & DELEAULT, PLLC, 41 BROOK STREET, MANCHESTER, NH, 03104, US

(21) Appl. No.: 10/050,883

(22) Filed: Nov. 9, 2001

Related U.S. Application Data
(60) Provisional application No. 60/314,063, filed on Aug. 22, 2001.

(51) Int. Cl. B29C 33/40

(52) U.S. Cl. 264/222; 425/175

(57) ABSTRACT

A saddle molding kit includes a sheet of moldable material sized to fit the area to be impressed and instructions for handling and using the sheet of moldable material to obtain a proper impression.

This application claims the benefit of U.S. Provisional Patent Application No. 60/314,063, filed Aug. 22, 2001.

### BACKGROUND OF THE INVENTION

1. Field of the Invention

The present invention relates generally to a method and apparatus for forming an impression of a portion of an animal body. Particularly, this invention relates to a method and apparatus for forming an impression of the back portion of an animal body. More particularly, the present invention relates to a method and apparatus of forming an impression of the back portion of a riding animal for use as a mold for making a saddle.

2. Description of the Prior Art

Accurate impressions of a portion of an animal body are used in a variety of fields including medicine, art and education. The conventional method of forming such an impression involves forming a mold of the desired body part such as by wrapping, for example, a leg with plaster bandages, permitting the plaster to harden, cutting the bandages, and then prying the bandages away from the leg. The plaster bandages are then used as a mold for casting a replica of the leg.

One problem with this technique is that when the plaster bandages are removed from the body portion of the animal, there is necessarily some distortion of the plaster. This results in a mold that is not exactly the same shape as the part being molded. Further, preparing the bandages, wrapping them about or onto the body portion, and then removing them is both time-consuming and messy. This technique is especially not useful for making an impression of the back of an animal such as a horse for the purpose of making a saddle for the animal.

One proposal for improving the conventional plaster bandage method of constructing molds is disclosed in U.S. Pat. No. 4,735,754 (1988, Buckner). This method involves encasing the body part with padding material, coating the padding material with petroleum jelly to prevent adhesion, and wrapping the padded body part with plaster bandages. After the plaster dries and hardens, the plaster bandages are cut and removed from the padded body part. The padding material is then removed and the body part is placed in the plaster bandage again. Alginate or other molding material is poured into the plaster form and permitted to set. The body part is then removed, leaving an impression of the body part in the alginate mold.

This system of forming molds suffers several disadvantages. The process is clumsy and time-consuming. The animal or person must endure two casting procedures, (1) being wrapped in padding material, having the plaster bandages applied, waiting for the plaster to dry and harden, and having the plaster form removed and (2) casting the alginate impression. The system is less useful for making molds of large areas or parts other than of a mere foot. This is due to the cracks and distortions that are introduced in the plaster form in removing it from the padded body part. It is also not very useful when making a mold of the back or abdomen. This technique is especially not useful for making an impression of the back of an animal such as a horse.

U.S. Pat. No. 4,828,116 (1989, Garcia) discloses a kit and a process for making a representative reproduction of a portion of the body of a person in a selected orientation. The kit includes a supply of impression material, a mold-defining cavity member, which may be in two parts, and a supply of plaster. The impression material, when combined with water, may be first positioned in the cavity of the mold and an impression made of the selected body portion. The selected body portion is removed from the cavity and a mix of plaster and water is placed in the impression made in the material in the cavity and allowed to set. Once set, the product of the mix is then removed.

A major disadvantage of this kit is the process is time-consuming and messy. It is also not practical for taking the impression of the back of an animal such as a horse, which is in a standing position.

The technique currently used to make a mold of a horse's back for use in saddle making is to shape a wire such as a coat hanger to the cross-sectional shape of the back of the horse. The wire shape is packaged by the horse owner as carefully as possible and shipped to the saddle maker. The saddle maker takes the shaped wire and uses the shaped wire to make a saddle that supposedly fits the particular horse. This assumes that the shape of the wire is not changed due to packaging and shipping. A further disadvantage of this system is the inaccuracy of the shaping procedure caused by the manual bending of the wire to represent the contour of the animals back. Another disadvantage is the fact that only one cross-sectional location on the animal's back is used to determine the shape of a saddle, which generally is made for placement on a horse's back from the withers to the lower back. Such a saddle has multiple cross-sectional positions all having a different contour depending on where the cross-section is taken.

The current method of taking the impression of the back of an animal, particularly a horse, in order to make a saddle that will fit the horse is fraught with error. As described, the error arises from various sources in the process. Proof of such error is apparent from the wide selection of wedge pads and specialized saddle pads that have been developed in an attempt to make a saddle fit a particular horse.

Therefore, what is needed is a kit and process for taking an impression of a portion of an animal's body that is less time-consuming and less messy. What is further needed is a kit and process that allows one to make an impression of an area of an animal's back when the animal is in a standing position.

### SUMMARY OF THE INVENTION

It is an object of the present invention to provide a kit and process for taking an impression of a portion of an animal's body that is less time-consuming and less messy. It is another object of the present invention to provide a kit and process capable of taking an impression of an area of an animal's back when the animal is in a standing position. It is yet another object of the present invention to provide a kit and process that takes an impression of a horse's back for forming a mold that is used to make a saddle having a better fit than saddles made using the current wire form method. It is still another object of the present invention to provide a method for packaging the kit in a convenient, space-saving, consumer-friendly, easy-to-use unit. It is another object of the present invention to provide a method of forming the moldable material that allows the moldable material to be easily packaged in an easy-to-use, consumer friendly packaging system.

The present invention achieves these and other objectives by providing a kit having a quantity of molded material in sheet form capable of taking an impression when activated and instructions for activating, using and impressing the quantity of molded material to take on the shape of the area being impressed. The molded material is sized to cover the particular portion of the animal's body of which an impression is desired. It is not only important to be able to take a relatively accurate impression of the relevant body portion, it is very important when making a saddle for a riding animal such as a horse.

A riding animal such as a horse performs best when its body and body parts are allowed to function in unison through its natural movement, i.e. its inborn mechanism. This mechanism is the same on all horses, no matter what their particular build or breed. The technical terms used to describe a horse's motion is called self-carriage, which lies at the root of collection. Collection occurs when the horse's “transmission” works properly. The vertical positions of the animal's forehead, the extra springiness of its steps and changes in its forward speed all result from the flawless functioning of the animal's loins, back and neck.

The biomechanical definition of collection calls for three independent motor functions that are all linked together. It begins when a horse coils its lumbosacral joint. This coiling is called engagement of the hindquarters. Collection continues when relaxation of the muscles of the horse's topline, combined with loin coiling, raises the back. Relaxation and stretching of the topline are always desirable. Contraction is undesirable. Collection is completed when the horse makes a neck-telescoping gesture. When the horse makes this gesture, it is said that the horse “goes onto the bit.” This is something that the animal does to the reins, not something the reins do to the animal.

When a rider can elastically follow the horse's motion by sifting in the stillpoint of the horse's back between the horse's withers and his loins, then the horse will be able to coil its loins and raise the root of its neck. When the horse coils its loins, not only does its back and the root of its neck rise, but also its pelvis and hocks become tucked up under the body. This is true engagement of the hindquarters. When the pelvis rotates downward on the lumbosacral joint bringing the hocks forward with it, the hind joints bend evenly and deeply. From this bend, and only from this bend, can the horse make powerful forward or upward springing movements. When the rider allows the horse's lower back, croup, thighs, and hocks to work in their natural coordination, even hard work poses no danger to a horse's soundness.

Animals such as horses come in a variety of sizes and shapes, and like people, no two horses are identical. Consequently, a saddle is made for a particular horse. Thus, saddle fit is important in allowing a horse to use its natural movement unhindered.

When a saddle does not properly fit a horse, problems occur and develop with the horse. These problems include, but are not limited to, neuro-muscular impingement and restriction, adhesions, lesions, blood flow restriction, lymphatic swelling, painful movement, numbness, irritability, and stress. Because these problems develop as a result of improper saddle fit, horse owners spend a great amount of time and money finding the right saddle fit. In the end, most horse owners end up buying a specialized saddle pad or try using blankets between the saddle and the horse to relieve some of these problems experienced by the horse.

A feature of the present invention is its ability to form or mold to the contour of the animal's back where the saddle is normally placed. Because the mold resembles the shape of the particular animal's back, a saddle maker is better able to make a saddle custom-designed to properly fit the particular horse without the need for a specialized saddle pad. The present invention is also quite useful for modifying existing/used saddles for a new horse. This is particularly important because of the cost of a new saddle, typically from about a thousand dollars to as much as several thousands of dollars. A properly fitting saddle along with proper rider balance eliminates the restrictions associated with impingements and creates optimal equine performance. In addition, for horses whose backs are so functionally distorted that a saddle cannot be made to fit properly, the present invention is useful for providing a mold for making specialized, custom-made orthopedic pads for a saddle.

A kit of the present invention allows a horse owner to get a properly fitting saddle for his/her horse. The kit includes a piece of moldable material and instructions for using the moldable material to obtain a proper impression of the area of the animal desired. The kit may optionally include a pair of gloves for working the moldable material before it sets. The kit may also include additional components such as a list of saddle makers, a shipping box to hold the molded material for shipment to a saddle maker, a shipping label, and shipping instructions.

Another feature of the kit is the rolled-up moldable material system packaged within a tube that is used both as a packaging container for shipment to the end user as well as the container for heating the mold material to proper temperature for use. The molding system includes a sheet of non-stick, flexible material overlaying the moldable material to prevent the moldable material from adhering to itself when heated to a moldable state.

To use the present invention, the piece of moldable material is heated to an elevated temperature in the range of about 100° F. to about 175° F. The piece of moldable material is heated sufficiently long to allow the moldable material to reach the desired temperature throughout. Heating the piece of moldable material for approximately 1 to 5 minutes typically is sufficient for the piece to be completely heated for molding. The length of time, however, may vary depending on the size of the piece of moldable material used.

Once the piece of moldable material has reached the desired temperature, the heated, moldable material is placed on the back of the animal, taking care to match up both the highest mark on the horses withers and the lowest point on the horses back while paying attention to the centerline, i.e. the spine. While the moldable material is still pliable and before it sets, the hands are used to cause the moldable material to conform to the animals back by applying pressure in an even, downward motion from the top of the center of the spine and pressing firmly over the withers all along the moldable material's area. As the mold begins to cool to its set temperature, the moldable material becomes rigid. Once it is sufficiently cooled below its set temperature so that the moldable material is rigid, the mold may be removed from the animal's back and sent to a saddle maker for making a new saddle that fits better or for re-fitting a used saddle.

Materials useful as a moldable component in the present invention are polymeric materials comprising at least one elastomer and one polycaprolactone. These temperature dependent materials may contain pigments sensitive to heat and whose color varies as a function of the temperature. This is useful for indicating when the polymeric material is at the softening temperature sufficient for taking an impression or, on the contrary, the material is at the rigidification temperature permitting its removal from the animal. The polymeric material may also incorporate a supplemental layer on one side to further prevent the material from sticking to the animal's skin while taking the impression.

Also useful as moldable materials are multi-part epoxies, UV-curable epoxies and UV-curable silicones contained between two plastic sheets closed on all four sides. The plastic sheets may be made of a flexible, polymeric material such as polyethylene or other materials having similar properties of flexibility, durability, weight, and cost for the present invention's intended use. The multi-part epoxies and silicones are kept from mixing with each other until ready to use by a mechanical means such as a clamp mechanism or a frangible seal. The multi-part epoxies are released within the package and the component parts are mixed with each other using an alternating squeezing action between the outside edges of the packaging. Once the multipart epoxies or silicones are thoroughly mixed, the flat sheet packaging containing the mixed epoxy or silicone is placed on the back of the animal and molded to conform to the back using the hands or other pressure-inducing mechanism for smoothing the package over the animal's back. The package is left on the animal's back until the moldable material has set, i.e. becomes rigid. Where a UV-curable material is used, the material is exposed to a UV source after it is conformed to the animal's back.

Yet another type of moldable material is a foam in a bag system that includes a bag formed of two sheets of flexible, plastic film material closed on all four side edges, a frangible seal that defines separate interior cells in a portion of the bag, a first foam precursor composition in one of the interior cells, and a second foam precursor composition in another of the interior cells. The frangible seal keeps the first and second foam precursors from reacting with each other until use. Once mixed, the first and second foam precursors generate expandable foam that solidifies after a certain reaction time. Typically, an isocyanate-containing component is mixed with a polyol-containing component and these components react to produce a urethane polymer (polyurethane), steam and carbon dioxide. The reaction creates foam that quickly expands into the major volume of the bag. While this is occurring, the hands or other mechanism is used to press the moldable material to conform to the animal's portion of which the impression is being made.

### BRIEF DESCRIPTION OF THE DRAWINGS

FIG. 1 is a plan view of the present invention showing one embodiment of a kit for making an impression of a portion of the body of an animal.

FIG. 2 is a perspective view of the present invention showing a two-part epoxy pouch used as the moldable material.

FIG. 3 is a perspective view of the present invention showing a foam-in-a-bag system used as the moldable material.

FIG. 4 is a side view of the present invention showing its placement on the back of a horse to form an impression for making a mold for later use in making a form fitting saddle.

FIG. 5 is a perspective view of the rolling system used in one embodiment for turning flat stock of the moldable material into a rolled shape.

FIG. 6 is a perspective view of the rolling mechanism used in the embodiment shown in FIG. 5 for forming the moldable material into a rolled shape.

FIG. 7 is an end view of the rolled, moldable material and nonstick sheet.

FIG. 8 is a perspective view of the packaging system showing the shipping/heating tube and the rolled, moldable material.

FIG. 9 is a cross-sectional view of the packaging system showing the rolled, moldable material within the shipping/heating tube being heated by hot water.

FIG. 10 is a perspective view of the moldable material being unrolled after heating.

### DETAILED DESCRIPTION OF THE PREFERRED EMBODIMENT

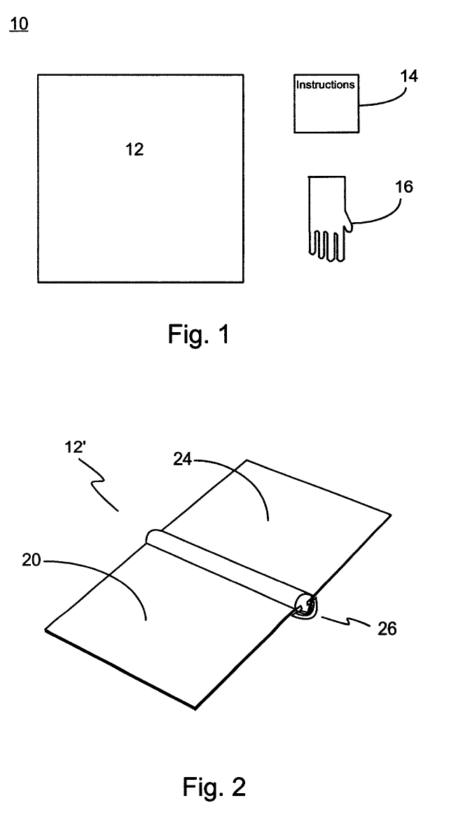

The preferred embodiment of the present invention is illustrated in FIGS. 1-10. FIG. 1 shows a molding kit 10 of the present invention, which includes a moldable material 12 in sheet form, instructions 14 for using moldable material 12 and at least one pair of gloves 16. The moldable material 12 is sized to fit the portion of the animal body that is intended to be molded. Some typical useful sizes are 18 inches by 18 inches square to as large as 48 inches by 48 inches square. It is noted that the actual shape of the moldable material 12 or the sleeve or bag that contains moldable material 12 may be any desired shape provided that the size is sufficient for the size of the intended impression area.

The preferred moldable material 12 is a polymeric material sheet having a typical thickness of about ⅛ of an inch. An acceptable material is available under the trade name Orthoplast® Splint (Product Code 9021, 9022) from Johnson & Johnson Professional, Inc., Raynham, Mass. The material composition is believed to be similar to that described in U.S. Pat. No. 6,083,442, which is herein incorporated by reference. The material composition is an elastomer-based material, typically a mixture of at least one elastomer and one polycaprolactone. The elastomer is typically a polyurethane. The elastomer ensures the elastic effect to match the contours of the area being impressed. The polycaprolactone ensures the effect of rigidification and blocking the deformation of the elastomer at ambient temperatures with sufficient softening for a small temperature deviation.

Other usable materials are multi-part epoxies in a divided pillow pouch. A two-part epoxy system 12′ is shown and illustrated in FIG. 2. The pillow pouch 12′ is sealed on its edges to contain the epoxy. The pouch 12′ has two mechanically separated chambers 22 and 24 where each chamber holds one of the parts of the two-part epoxy. It is noted that the pouch 12′ may have as many mechanically separated chambers as required for each part of a multi-part epoxy, each chamber containing one of the parts of the epoxy. The pouch 12′ is, in its simplest form, made of two plastic sheets that are flexible. An acceptable plastic sheet is made of a polymeric material such as polyethylene or materials having similar properties of flexibility, durability, weight, and cost for the present invention's intended use. Each chamber is separated from the other chambers by a mechanical mechanism 26 such as a clamp or frangible seal. When the clamps are released or the frangible seals are broken, the epoxy components are mixed with each other using any one of a variety of techniques to manipulate the epoxy components such that they become thoroughly mixed with each other. After mixing, which may take approximately thirty to sixty seconds, the pouch 12′ containing the mixed epoxy is placed on the horse's back and pressed in a manner previously described to conform the pouch to the animal's back until the epoxy cures, i.e. hardens. The hardening time is dependent on the type of epoxy used and can range from a few minutes to several hours. The least amount of time required for maintaining the moldable material on the animal's back while providing sufficient time to properly work the material into a conforming shape is preferred. One advantage of the epoxy system is it does not need to be preheated to provide a sufficiently quick reaction time such as required by both the polymeric materials and the foaming systems, or for workability.

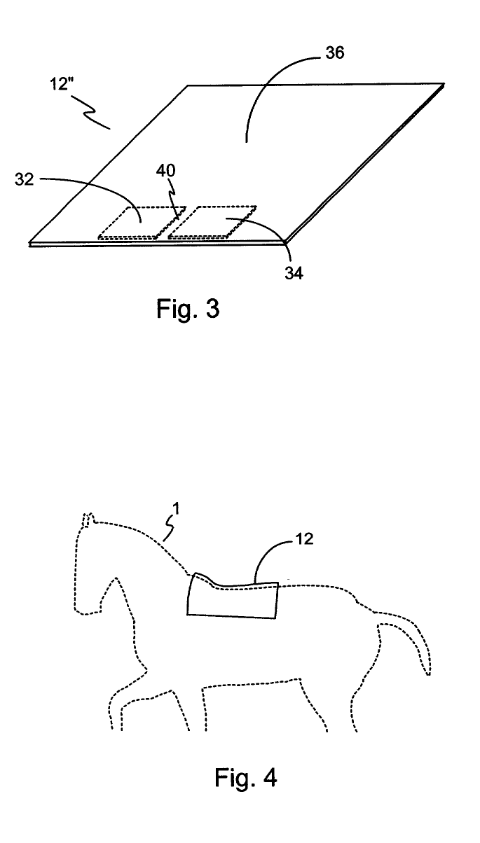

Another system that is usable as a molding material is a foam-in-a-bag system 12″ shown in FIG. 3. The foam-in-a-bag system 12″ includes a bag formed of two sheets of flexible, plastic film material closed on all four side edges, a frangible seal 40 that defines separate interior cells 32 and 34 in a portion of the bag, a first foam precursor composition in one of the interior cells, and a second foam precursor composition in another of the interior cells. Examples of such systems are shown and described in U.S. Pat. Nos. 4,800,708, 4,854,109 4,938,007 5,027,583 5,139,151 5,376,219 5,899,325, and 5,996,782. Typical materials used for the foam are polyurethane foam resin-based materials.

Frangible seal 40 between the cells containing the first and second precursor compositions prevents premature mixing and reaction between the precursor compositions. Typically, the frangible seal is broken by applying a quick impact pressure. Once broken, the compositions are quickly mixed and a reaction occurs creating expandable foam that flows into chamber volume 36 and solidifies after a given reaction time. The components are typically heated to a temperature of about 140° F. to about 150° F. before reacting the precursor compositions with each other. Typical precursor compositions include an isocyanate containing component in one precursor and a polyol containing component in a second precursor, which react with each other to produce a polyurethane, steam and carbon dioxide. The reaction creates foam that expands into the major volume 26 of the bag. As describe with previous moldable material systems, the hands or other mechanism is used to press the expanding foam so that the bag conforms to the animal's back forming an impression of the animal's back. The foam hardens is a few minutes retaining the impression created.

To use the preferred moldable material, sheet 12 of moldable material is heated long enough so that substantially the entire sheet reaches a temperature in the range of about 100° F. to about 175° F. A temperature nearer the higher end of the range is preferred to provide a longer working life of the moldable material before it solidifies. Solidification occurs as the material cools below the working temperature range. Heating the moldable material may be accomplished by placing the material in a heated oven or in hot water. A hand-held hair dryer can also be used to heat the material. Typically, the heating of the material should be maintained for at least fifteen minutes to ensure that the material is thoroughly heated throughout.

When sheet 12 of the moldable material has been heated to the desired temperature, sheet 12 is removed from the source of the heat and is then placed onto the back of the horse. Sheet 12 is quickly aligned with the midline of the horses back, i.e. the spine. The alignment is such that the highest point on the horse's withers and the lowest point on the horses back are covered with equal areas of sheet 12 to each side of the horse. This is illustrated in FIG. 4. Immediately following placement and alignment of sheet 12 on the horse's back, sheet 12 is pressed firmly in a downward motion from the top of the center of the spine down over the horse's withers. Sheet 12 is secured to the horse's back making sure that all material is firmly pressed and formed to the horse's back.

After forming the mold, it is sent to a saddle maker to make a saddle that conforms to the shape of the horse from which the mold impression was obtained.

There is also invented a process for rolling the flat sheet stock and a packaging system that is easy-to-use, consumer friendly and inexpensive. Conventional wisdom of the manufacturers of the moldable sheet material is that the flat sheet stock of the moldable material would retain some memory of its prior shape once the material was heated and shaped then reheated to form another shape. It was also conventional wisdom that the moldable material had to be heated to at least 140° F. for a predetermined amount of time in order to allow molding of the material. Further, the preferred heating method required the use of an oven. This is impractical for taking a mold of an area on an animal, specifically a horse's back and withers for a saddle, because barns typically do not have heating ovens as these present a fire danger in the barn. In addition, heating in an oven causes the moldable material to emit gaseous fumes that are a health hazard to both the user and the animal.

Contrary to conventional wisdom, processes for rolling the material and for packaging the material were successfully devised and used. Further, these processes provide for a unique packaging system that allows the packaging to serve a dual purpose, one for shipping the product to the end user and a second to provide an easy-to-use, consumer friendly method of heating the moldable material. It should be understood that rolling of the moldable sheet material may be accomplished after manufacturing of the sheet or during the manufacturing process. The present invention is meant to cover the packaging of the material in the rolled-up form regardless of the process used to provide a moldable sheet in a roll.

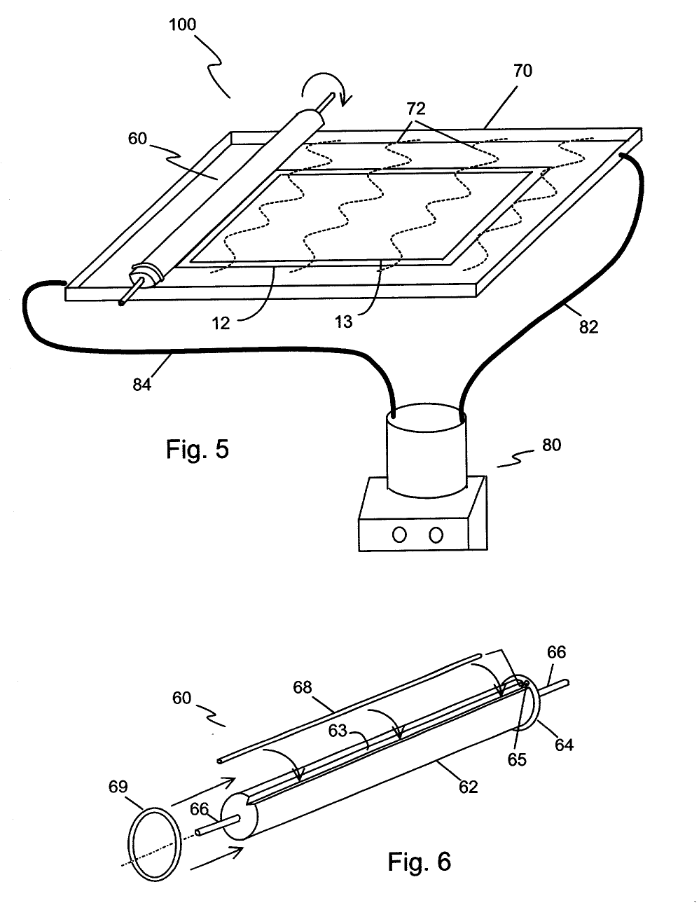

Turning now to FIG. 5, there is shown a moldable sheet rolling system 100 for heating and rolling the flat sheet moldable material. Rolling system 100 includes a tray 70, a water heater unit 80, water lines 82 and 84, and rolling mechanism 60. As illustrated, moldable sheet 12 and nonstick sheet 13 are submerged below water surface 72. Water heater unit 80 contains a reservoir of heated water (not shown) and a circulating pump (not shown). Water heater unit 80 with a circulating pump are conventional items. The circulating pump circulates the heated water through tray 70. Tray 70 is sized to accept the size of the moldable sheet 12 to be used and has a depth typically of about 1.5 inches. It should be understood that this system may be automated, which is within the skill of the art of a person who designs automated systems.

The process includes placing a moldable sheet 12 into tray 70 that contains the heated circulating water. The temperature of the water is typically in the range of about 100° F. to about 175° F., but preferably around 160° F. Nonstick flexible sheet 13 may be coupled with moldable sheet 12 before placement into tray 70 or it may be coupled to sheet 12 when the rolling process begins. Nonstick sheet 13 is preferably a thin sheet of polyethylene, but any nonstick material such as wax paper, teflon, and the like may be used. Once heated to temperature, which takes approximately 1 to 5 minutes, sheet 12 is attached to roller mechanism 60 and rolled into a coil shape. Nonstick sheet 13 prevents sheet 12 from sticking to itself when heated to its moldable temperature. After rolling, roller mechanism 60 with sheet 12 is removed from tray 70 and allowed to cool below its “flow” temperature, i.e. sheet 12 becomes rigid. This typically takes about 1 to 5 minutes at room temperature. Once sheet 12 becomes rigid, it is removed from roller mechanism 60 and ready to be packaged. It should be understood that sheet 12 may be attached to roller mechanism 60 before it is heated in tray 70 and that nonstick sheet 13 may also be either attached to roller mechanism 60 or not.

FIG. 6 shows the preferred embodiment of the roller mechanism 60. Roller mechanism 60 includes a roller cylinder 62, a roller pin 68 and a pin retainer ring 69. Roller cylinder 62 has a groove 63 along its length, a pair of roller handles 66 at each end of cylinder 62, and roller end plate 64 on one end of cylinder 62 between cylinder 62 and handle 66. Roller end plate includes a recess 65 positioned in axial alignment with groove 63 and sized to receive a first end of roller pin 68. Pin retainer ring 69 is sized and shaped to fit around cylinder 62 and to hold a second end of roller pin 68 within groove 63.

In use, a forward edge of sheet 12 is received into groove 63. First end of roller pin 68 is inserted into recess 65 causing roller pin 68 to lie along groove 63 and trapping forward edge of sheet 12 within groove 63. Retainer ring 69 is then slid over the end of cylinder 62 and roller pin 68. Once sheet 12 is heated, roller mechanism 60 is rolled to wrap sheet 12 about cylinder 62. Of course, nonstick sheet 13 must be coupled to sheet 12, either before heating or after heating, to prevent heated sheet 12 from sticking to itself. Nonstick sheet 13 may or may not be attached to roller mechanism 60 when sheet 12 is captured by roller mechanism 60. Once rolled sheet 12 is cooled below its “flow” temperature, sheet 12 along with nonstick sheet 13 is removed from roller mechanism 60. Because sheet 12 is rigid at room temperature, sheet 12 retains its rolled/coiled shape.

Turning now to FIG. 7, there is illustrated an enlarged end view of rolled sheet 12. As can be seen, nonstick sheet 13 prevents moldable sheet 12 from sticking to itself when heated to its “flow” temperature. The spacing between moldable sheet 12 and nonstick sheet 13 is enlarged to better view the relationship between moldable sheet 12 and nonstick sheet 13.

FIG. 8 shows a packaging system for shipping the moldable material to an end user. Packaging system 50 includes a tube 52, a first end cap 54 and a second end cap 56. First end cap 54 is preferably fixed to one end of tube 52 forming a water-tight seal. Second end cap 56 is removable. Rolled moldable sheet 12 is inserted into tube 52 and second end cap 56 is attached forming a self-contained package. Tube 52 is made of a leak-proof material having relatively low thermal conductivity. The thermal conductivity of the material is such that it is sufficient to maintain the temperature of a heated liquid such as water placed into the tube for a time long enough to cause moldable sheet 12 to become moldable. The preferred material is PVC tubing commonly used in plumbing. The diameter of the tube 52 will depend on the size of moldable sheet 12 used. Examples of acceptable tubing are 4-inch and 6-inch diameter tubing. The end caps 54 and 56 are also preferably made of PVC material.

FIG. 9 shows the packaging system as used by an end user. There is shown packaging system 50 containing moldable sheet 12 rolled up as shown in FIG. 7. When the end user is ready to use the present invention, the end user simply uses hot tap water having a temperature of about 100° F. or more and fills tube 52 with hot water 58 to cover moldable sheet 12. Moldable sheet 12 reaches a relatively uniform temperature in about 1 to 5 minutes, depending on the size of sheet 12. Once moldable sheet 12 is heated to its molding temperature, water 58 is emptied from tube 52 and moldable sheet 12 is removed from tube 52. Moldable sheet 12 with nonstick sheet 13 is then unrolled, as shown in FIG. 10. Moldable sheet 12 is then immediately positioned on the animal, specifically over the horse's back and withers, and molded to shape as previously described.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An animal molding kit comprising:
a sheet of moldable material sized to take an impression of a predefined area on said animal; and
instructions for handling, heating and using said sheet of moldable material.

2. The kit of claim 1 wherein said kit further comprising a pair of gloves.

3. The kit of claim 1 wherein said moldable material is one of an elastomer-based material, an epoxy-based material or a polyurethane foam resin-based material.

4. The kit of claim 1 wherein said molding sheet has indicia for aligning said molding sheet with said predefined area.

5. The kit of claim 4 wherein said instructions further include indicia aligning instructions.

6. A saddle molding kit comprising:
a sheet of moldable material sized to fit an area of a horse's back and withers sufficient to take an impression of said area for making a fitted saddle; and
instructions for handling, heating and using said sheet of moldable material to make said impression.

7. The kit of claim 6 further comprising a pair of gloves for handling and molding said sheet of moldable material.

8. The kit of claim 6 further comprising a list of saddle makers capable of receiving said impression for making a fitted saddle.

9. The kit of claim 6 wherein said sheet of moldable material includes indicia for aligning said molding sheet over said horse's back and withers.

10. The kit of claim 9 wherein said instructions further include indicia aligning instructions.

11. The kit of claim 6 wherein said moldable material is one of an elastomer-based material, an epoxy-based material or a polyurethane foam resin-based material.

12. A method of using a moldable kit for taking an impression of a predefined area of an animal, said method comprising:
obtaining a sheet of moldable material having a sufficient size to take said impression of said predefined area;
heating said sheet of moldable material to a temperature and for a period of time sufficient to precondition said material for molding;
applying said sheet to said predefined area;
pressing said sheet about said predefined area causing said sheet to conform to the contours of said predefined area; and
waiting until said sheet rigidifies while said sheet is in contact with said predefined area before removing said sheet from said predefined area.

13. The method of claim 12 further comprising manipulating said sheet of moldable material to enable mixing of the components of said moldable material after heating but before applying said sheet to said predefined area when said moldable material is an epoxy-based or a polyurethane foam resin-based material.

14. The method of claim 12 wherein said waiting step includes cooling said sheet below the working temperature of said moldable material when said moldable material is an elastomer-based material.

15. A method of using a saddle molding kit for making a fitted saddle comprising:
obtaining a sheet of a mold forming material having sufficient size to take an impression of a horse's back and withers for making a saddle;
heating said sheet to a temperature and for a period of time sufficient to precondition said sheet for molding;
applying said sheet to said horse's back and withers;
pressing said sheet about said horse's back and withers causing said sheet to conform to the contours of said predefined area; and
waiting until said sheet rigidifies while said sheet is in contact with said horse's back and withers before removing said sheet from said horse's back.

16. The method of claim 15 further comprising manipulating said sheet of moldable material to enable mixing of the components of said moldable material after heating but before applying said sheet to said predefined area when said moldable material is an epoxy-based or a polyurethane foam resin-based material.

17. The method of claim 15 wherein said waiting step includes cooling said sheet below the working temperature of said moldable material when said material is an elastomer-based material.
